(19) United States
(12) Patent Application Publication
(10) Pub. No.: US 2026/0339749 A1
(43) Pub. Date: Oct. 29, 2026

(54) CLOUD COMPUTING INSTANCE CREATION METHOD AND APPARATUS

(71) Applicant: CLOUD INTELLIGENCE ASSETS HOLDING (SINGAPORE) PRIVATE LIMITED, Singapore (SG)

(72) Inventors: Jing ZHOU, Beijing (CN); Geng REN, Hangzhou, Zhejiang (CN)

(21) Appl. No.: 19/123,040

(22) PCT Filed: Sep. 25, 2023
(86) PCT No.: PCT/CN2023/121146

§ 371 Date: Apr. 21, 2025

(30) Foreign Application Priority Data
Oct. 20, 2022 (CN) 202211288355.6

(51) Int. Cl. G06F 9/50; G06F 9/48

(52) U.S. Cl. CPC G06F 9/5083; G06F 9/4881

(57) ABSTRACT

One or more embodiments of this specification provide a cloud computing instance creation method and apparatus. The method includes: performing resource orchestration, based on at least one resource orchestration dimension, for a cloud computing resource hosted on at least one edge cloud node, to create a cloud computing resource set corresponding to each resource orchestration dimension; in response to a cloud computing instance creation requirement built by a tenant based on at least part of the resource orchestration dimension, determining, from a cloud computing resource set corresponding to the at least part of the resource orchestration dimension, a target cloud computing resource that matches the requirement; performing scheduling for the target cloud computing resource, to create a cloud computing instance that meets the requirement on an edge cloud node hosting the target cloud computing resource, and return cloud computing instance information of the created cloud computing instance to the tenant.

### CROSS-REFERENCE TO RELATED APPLICATIONS

The present application is a National Stage of International Application No. PCT/CN2023/121146, filed on Sep. 25, 2023, which claims priority to the Chinese Patent Application No. 202211288355.6, entitled “CLOUD COMPUTING INSTANCE CREATION METHOD AND APPARATUS” and filed with the China National Intellectual Property Administration on Oct. 20, 2022. These applications are hereby incorporated by reference in their entireties.

### TECHNICAL FIELD

One or more embodiments of this specification relate to the field of edge cloud computing technologies and, in particular, to a cloud computing instance creation method and an apparatus, an electronic device, and a machine-readable storage medium.

### BACKGROUND

Edge cloud is a cloud computing platform built on an edge infrastructure based on the core of cloud computing technologies and the capabilities of edge computing.

As more and more edge services are considered to be migrated onto edge cloud, an increasing number of central applications with high localization characteristics, suitable for running on edge cloud nodes, are also offloaded to the edge, and the demand for edge cloud utilization continues to rise. Currently, there is no effective solution for cloudifying and delivering resources in edge cloud scenarios, and cloud providers usually delegate the implementation of resource management and control logic to users.

In fact, during the edge cloud utilization process, users' main need is to run their services smoothly and conveniently on the edge cloud. In other words, users expect to be able to simply launch the services by creating corresponding instances on the edge cloud nodes based on images without needing to handle complex resource management and control, or other operational and maintenance tasks on the edge cloud nodes. Moreover, in order to retain users, “cloud migration strategies” (that is, specific operating manners for users to utilize the edge cloud) currently offered by different cloud providers are generally diverse and not universal. Therefore, in the process of using edge cloud computing services provided by different cloud providers, users usually need to respectively implement their resource management and control logic for different “cloud migration strategies” provided by different cloud providers, further reducing the efficiency and user experience in the edge cloud utilization.

### SUMMARY

The present application provides a cloud computing instance creation method, where the method is applied to a central management and control device in a distributed edge cloud computing system; the edge cloud computing system further includes at least one edge cloud node interconnected with the central management and control device; and the method includes: performing resource orchestration, based on at least one resource orchestration dimension, for a cloud computing resource hosted on the at least one edge cloud node, to create a cloud computing resource set corresponding to each resource orchestration dimension of the at least one resource orchestration dimension; in response to a cloud computing instance creation requirement built by a tenant based on at least part of the at least one resource orchestration dimension, determining, from the cloud computing resource set corresponding to each resource orchestration dimension, a cloud computing resource set corresponding to the at least part of the at least one resource orchestration dimension, and determining, from the determined cloud computing resource set, a target cloud computing resource that matches the cloud computing instance creation requirement; performing scheduling for the target cloud computing resource, to create a cloud computing instance that meets the cloud computing instance creation requirement on an edge cloud node hosting the target cloud computing resource, and return cloud computing instance information of the created cloud computing instance to the tenant.

The present application further provides a cloud computing instance creation apparatus, where the apparatus is applied to a central management and control device in a distributed edge cloud computing system; the edge cloud computing system further includes at least one edge cloud node interconnected with the central management and control device; and the apparatus includes: a first creating unit, configured to: perform resource orchestration, based on at least one resource orchestration dimension, for a cloud computing resource hosted on the at least one edge cloud node, to create a cloud computing resource set corresponding to each resource orchestration dimension of the at least one resource orchestration dimension; a determining unit, configured to: in response to a cloud computing instance creation requirement built by a tenant based on at least part of the at least one resource orchestration dimension, determine, from the cloud computing resource set corresponding to each resource orchestration dimension, a cloud computing resource set corresponding to the at least part of the at least one resource orchestration dimension, and determine, from the determined cloud computing resource set, a target cloud computing resource that matches the cloud computing instance creation requirement; a second creating unit, configured to: perform scheduling for the target cloud computing resource, to create a cloud computing instance that meets the cloud computing instance creation requirement on an edge cloud node hosting the target cloud computing resource, and return cloud computing instance information of the created cloud computing instance to the tenant.

The present application further provides an electronic device, including a communication interface, a processor, a memory, and a bus, where the communication interface, the processor and the memory are interconnected to each other via the bus; the memory stores machine-readable instructions therein, and the processor executes, by invoking the machine-readable instructions, the aforementioned method.

The present application further provides a machine-readable storage medium storing machine-readable instructions, when the machine-readable instructions are invoked and executed by a processor, the aforementioned method is implemented.

### BRIEF DESCRIPTION OF DRAWINGS

In order to illustrate the technical solutions of embodiments of this specification more clearly, the drawings required for the description of the embodiments will be briefly introduced below. Obviously, the drawings in the following description are merely intended for some embodiments described in this specification; and for those of ordinary skill in the art, other drawings can be obtained according to these drawings without making creative efforts.

FIG. 1 is a schematic diagram of a system architecture of a distributed edge cloud computing system illustrated by an illustrative embodiment;

FIG. 2 is a flowchart of a cloud computing instance creation method illustrated by an illustrative embodiment;

FIG. 3 is a schematic diagram of a system architecture of another distributed edge cloud computing system illustrated by an illustrative embodiment;

FIG. 4 is a schematic structural diagram of an electronic device where a cloud computing instance creation apparatus is located, illustrated by an illustrative embodiment; and

FIG. 5 is a block diagram of a cloud computing instance creation apparatus illustrated by an illustrative embodiment.

### DESCRIPTION OF EMBODIMENTS

In order to enable those skilled in the art to better understand technical solutions in this specification, the technical solutions in the embodiments of this specification will be clearly and completely described below in conjunction with the drawings in the embodiments of this specification. Obviously, the described embodiments are merely part of the embodiments of this specification, rather than all of the embodiments. Based on the embodiments in this specification, all other embodiments obtained by those of ordinary skill in the art without making creative work shall fall within the protection scope of this specification.

It should be noted that in other embodiments, the steps of a corresponding method are not necessarily executed in the order illustrated and described in this specification. In some other embodiments, the method thereof may include more or fewer steps than those described in this specification. In addition, a single step described in this specification may be decomposed into multiple steps for description in other embodiments; and multiple steps described in this specification may be combined into a single step for description in other embodiments.

Edge cloud is a cloud computing platform built on an edge infrastructure based on the core of cloud computing technologies and the capabilities of edge computing. The edge cloud can also be referred to as an edge cloud computing system, an edge cloud computing platform, or the like.

The edge cloud is a relative concept, which can be distinguished from a central cloud or a traditional cloud computing platform. In actual applications, the central cloud or the traditional cloud computing platform may include a data center with large-scale resources and centralized locations; while the edge cloud nodes cover a wider network range, are closer to terminals, and are more numerous, but a single edge cloud node has a smaller resource scale.

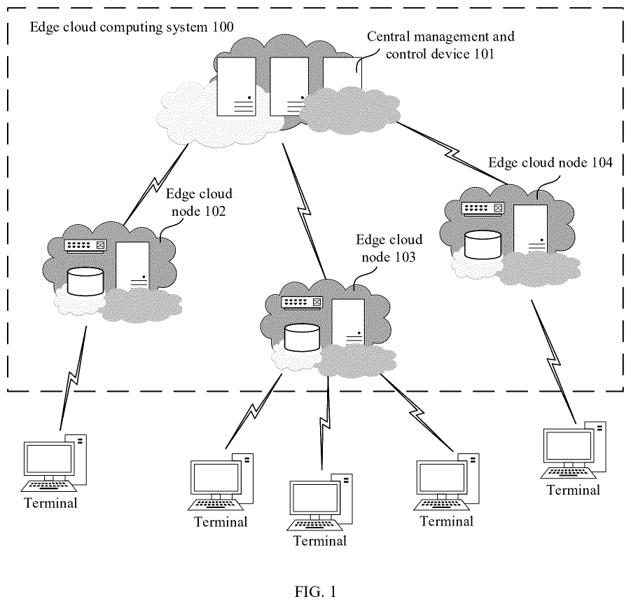

Please refer to FIG. 1, which is a schematic diagram of a system architecture of a distributed edge cloud computing system illustrated by an illustrative embodiment. As shown in FIG. 1, the edge cloud computing system 100 may include a central management and control device 101, an edge cloud node 102, an edge cloud node 103, and an edge cloud node 104; and the central management and control device 101 may be interconnected with the edge cloud node 102, the edge cloud node 103, and the edge cloud node 104, respectively.

It should be noted that FIG. 1 simply shows three edge cloud nodes for exemplary purposes, without implying any special limitation on this specification; and in actual applications, the edge cloud computing system 100 may include at least one edge cloud node interconnected with the central management and control device 101. The central management and control device 101 may be deployed in one or more cloud computing data centers, or in one or more traditional data centers, which is not specifically limited in this specification.

Each edge cloud node in the at least one edge cloud node may include a series of edge infrastructures. Specifically, the edge infrastructure may include but is not limited to: distributed data centers (DCs), wireless computer rooms or clusters, operators' communication networks, core network devices, base stations, edge gateways, home gateways, computing devices or storage devices, and other edge devices, as well as their corresponding network environments, etc. It should be noted that different edge cloud nodes may have the same or different locations, they may provide the same or different cloud computing capabilities, and may include the same or different edge infrastructure. This specification does not impose specific limitations on these aspects.

A terminal as shown in FIG. 1 may include a demand-side of cloud computing services. For example, the terminal may include a user terminal in the Internet or the Internet of Things.

In the system architecture of the edge cloud computing system as shown in FIG. 1, a central cloud corresponding to the central management and control device, an edge cloud formed by the at least one edge cloud node, and the terminal can form an end-to-end technical architecture of “cloud-edge-end tripartite collaboration”. In the edge cloud computing system 100, the central management and control device 101 can take each edge cloud node (such as the edge cloud node 102, the edge cloud node 103, and the edge cloud node 104) as a managed and controlled object, and perform unified management and control in terms of resource scheduling, image management, instance management and control, operation and maintenance, network, security, etc. This enables cloud computing services to be processed within each edge cloud node, thereby leveraging various resources hosted on the edge cloud node to provision cloud computing services for users. As edge cloud nodes are closer to user terminals, this architecture can reduce the response latency of cloud computing services, alleviate the pressure on the central cloud or the traditional cloud computing platform corresponding to the edge cloud nodes, lower bandwidth costs, and meet the resource requirements of terminals for massive connectivity, low latency, and high bandwidth in cloud computing scenarios.

In practical applications, the edge cloud node can create a corresponding instance according to an image and provide various externally accessible cloud computing services through the instance. The image is a foundational file required to create an instance in the edge cloud node; for example, the image may be an image file (such as an operating system, application, or operation configuration) required to provide cloud computing services for users. For example, it may be a file that is generated in a certain format according to a series of specific files and meets the computational deployment requirement(s) of the edge cloud node. In addition, the image may be in various forms, such as a virtual machine (VM) image file, a container (Docker) image file, or various types of application package files, etc. The image form may be related to a virtualization technology required for cloud computing services, which is not limited in this specification. Corresponding to the image, the implementation form of the instance may be a virtual machine, container, application, etc.

In addition, in the system architecture of the edge cloud computing system as shown in FIG. 1, in addition to the central management and control device 101, the edge cloud computing system 100 may also include one or more edge management and control devices. The edge management and control device(s) can be configured to assist and cooperate with the central management and control device to manage, control and schedule the at least one edge cloud node, thereby improving the management, control and scheduling of the edge cloud node by the central management and control device, and achieving the full utilization of edge resources.

The edge management and control device can be deployed in one or more edge cloud nodes. In an implementation, each edge cloud node may include one or more resource devices, and the edge management and control device can be deployed on one or more resource devices. Alternatively, in addition to the resource device, each edge cloud node may also include one or more proprietary devices that are different from the resource device and specifically configured to deploy the edge management and control device, and the edge management and control device can be deployed on the one or more proprietary devices. The edge management and control device can also be deployed together with the central management and control device, which is not be specifically limited in this specification.

As more and more edge services are considered to be migrated onto edge cloud, an increasing number of central applications with high localization characteristics, suitable for running on edge cloud nodes, are also offloaded to the edge, and the demand for edge cloud utilization continues to rise. Currently, there is no effective solution for cloudifying and delivering resources in edge cloud scenarios, and cloud providers usually delegate the implementation of resource management and control to users. This means that users usually need to manage and control physical resources they own and implement their resource management and control logic.

In fact, during the edge cloud utilization process, users' main need is to run their services smoothly and conveniently on the edge cloud. In other words, users expect to be able to simply launch the services by creating corresponding instances on the edge cloud nodes based on images without needing to handle complex resource management and control, or other operational and maintenance tasks on the edge cloud nodes. Moreover, in order to retain users, “cloud migration strategies” currently offered by different cloud providers are generally diverse and not universal. The term “cloud migration strategies” may include the meaning of which cloud users migrate to and how to migrate to the cloud, which can be used to represent specific operational approaches for users to utilize the edge cloud. Therefore, in the process of using edge cloud computing services provided by different cloud providers, users usually need to respectively implement their resource management and control logic for different “cloud migration strategies” provided by different cloud providers, further reducing the efficiency and user experience in the edge cloud utilization.

From the above-illustrated embodiments, it can be seen that since edge resources have characteristics of distributed, heterogeneous, integrated, miniaturized, and wide-coverage, resource management and control, as well as service operation and maintenance in edge cloud computing scenarios are more complex and difficult compared to traditional central cloud scenarios, which results in relatively low efficiency and poor experience for users utilizing the edge cloud, and may also cause waste of edge resources.

In view of this, this specification aims to propose a technical solution based on one or more resource orchestration dimensions. The central management and control device in the edge cloud computing system uniformly orchestrates resources, thereby offering users a convenient and easy-to-use solution for utilizing the edge cloud.

During the implementation, the central management and control device in the distributed edge cloud computing system can perform resource orchestration, based on at least one resource orchestration dimension, for a cloud computing resource hosted on at least one edge cloud node interconnected with the central management and control device in the edge cloud computing system, to create a cloud computing resource set corresponding to each resource orchestration dimension of the at least one resource orchestration dimension; further, the central management and control device can determine, in response to a cloud computing instance creation requirement built by a tenant based on at least part of the at least one resource orchestration dimension, from the cloud computing resource set corresponding to each resource orchestration dimension, a cloud computing resource set corresponding to the at least part of the at least one resource orchestration dimension, and determine, from the determined cloud computing resource set, a target cloud computing resource that matches the cloud computing instance creation requirement; and further, the central management and control device can perform scheduling for the target cloud computing resource, to create a cloud computing instance that meets the cloud computing instance creation requirement on an edge cloud node hosting the target cloud computing resource, and return cloud computing instance information of the created cloud computing instance to the tenant.

It can be seen that in the technical solution in this specification, on the one hand, the central management and control device (that is, the platform side) in the distributed edge cloud computing system can perform resource orchestration, based on the at least one resource orchestration dimension, for the cloud computing resource hosted on the edge cloud node, to realize the migration of resources onto the cloud in an efficient, flexible and scalable manner.

On the other hand, the central management and control device can perform resource orchestration for the cloud computing resource based on the at least one resource orchestration dimension, and the tenant can build the cloud computing instance creation requirement based on the at least one resource orchestration dimension. Therefore, through a unified multi-dimensional resource modeling strategy, the process of orchestrating the cloud computing resource is decoupled from the process of producing the cloud computing instance, while it is possible to seamlessly bridge the workflow between resource orchestration by the central management and control device and tenants' edge cloud utilization, making the model for resource management and control and instance production transparent, thereby improving the efficiency of tenants' edge cloud utilization.

On the further hand, in the edge cloud utilization process, tenants are not required to focus on underlying physical resources corresponding to individual edge cloud nodes, nor do they need to learn complex cloud usage strategies of various cloud providers. The tenants only need to build the cloud computing instance creation requirement based on the at least one resource orchestration dimension, and the central management and control device can determine the cloud computing resource that matches the cloud computing instance creation requirement as the target cloud computing resource from the cloud computing resource set, and can perform scheduling for the determined target cloud computing resource, to create the cloud computing instance that meets the cloud computing instance creation requirement on the corresponding edge cloud node. This approach allows the platform side to adopt a “cloud-neutral” stance, providing tenants with a more flexible, efficient, and scalable manner of utilizing the edge cloud, thereby creating more service value for the tenants, and tenants are not bound by the platform side, which can improve their experience in utilizing the edge cloud.

The present application is described below through specific embodiments in combination with specific application scenarios.

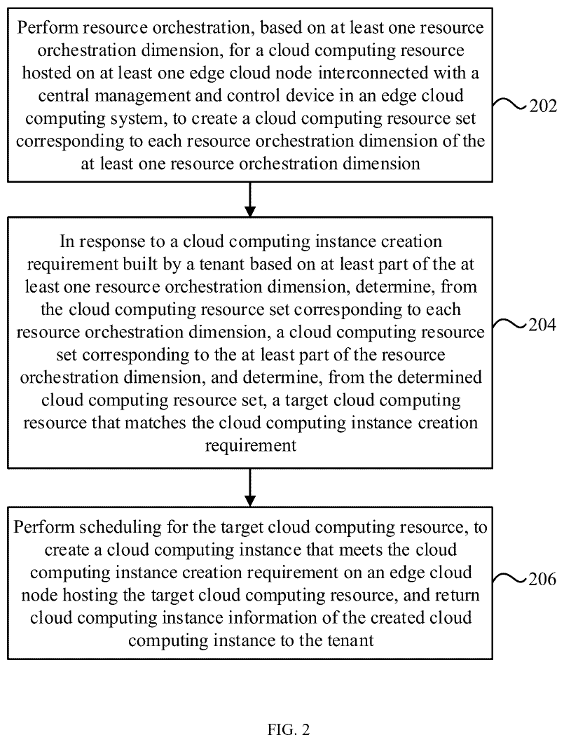

Please refer to FIG. 2, which is a flowchart of a cloud computing instance creation method illustrated by an illustrative embodiment. The method may be applied to the central management and control device 101 as shown in FIG. 1. The method may include steps as follows.

Step 202, perform resource orchestration, based on at least one resource orchestration dimension, for a cloud computing resource hosted on at least one edge cloud node interconnected with a central management and control device in an edge cloud computing system, to create a cloud computing resource set corresponding to each resource orchestration dimension of the at least one resource orchestration dimension.

In this specification, the resource orchestration can be understood as abstracting physical resources in the edge cloud computing system into manageable and controllable cloud computing resources through modeling and orchestration.

For example, preset resource orchestration dimensions may include these three resource orchestration dimensions: a city, a computer room (IDC, Internet Data Center), and an operator (ISP, Internet Service Provider). As shown in FIG. 1, the central management and control device 101 can classify, based on these three resource orchestration dimensions of city, computer room and operator, cloud computing resources hosted on the edge cloud node 102, the edge cloud node 103, and the edge cloud node 104, and can create, based on a classification result, a cloud computing resource set corresponding to each resource orchestration dimension.

In an implementation, each resource orchestration dimension may include several resource orchestration sub-dimensions, and the cloud computing resource set corresponding to each resource orchestration dimension may include a cloud computing resource subset corresponding to each resource orchestration sub-dimension.

For example, the resource orchestration dimension of the computer room may include resource orchestration sub-dimensions respectively corresponding to different computer rooms (such as IDC1, IDC2, etc.). The cloud computing resource set corresponding to the computer rooms can be divided into cloud computing resource subsets respectively corresponding to respective computer rooms, where the cloud computing resource subset corresponding to the computer room IDC1 may include cloud computing resource(s) deployed in the computer room IDC1.

It should be noted that in the above-illustrated embodiments, the cloud computing resource sets respectively corresponding to the respective resource orchestration dimensions may or may have intersections. The specification does not impose any specific limitations on this aspect. However, a plurality of cloud computing resource subsets included in the cloud computing resource set corresponding to a certain resource orchestration dimension should have no intersection. For example, the cloud computing resource subset corresponding to the computer room IDC1 may simply include cloud computing resource(s) deployed in the computer room IDC1, but not cloud computing resource(s) deployed in other computer rooms.

In this specification, the cloud computing resource may still be in the form of a physical resource or logical resource. An MCU (Meta Control Unit) may serve as the smallest management and control unit for resource orchestration, and it can encapsulate atomic management and control capabilities.

For example, an individual physical resource (such as an ARM (Advanced RISC Machine) board, a hard disk, etc.) can be treated as an MCU and converted into corresponding cloud computing resources.

For another example, physical resources can be abstracted into logical resources (such as 10 GB of storage space, 100 MB of bandwidth, etc.), and the logical resources can be converted into corresponding cloud computing resources according to the MCU. In a possible embodiment, the cloud computing resource can be further split or grouped for management based on actual requirements (such as a resource quantity, etc.). For example, if a storage medium can provide 1 TB of storage space, the 1 TB of storage resources corresponding to the storage medium can be split into multiple smaller storage resources to facilitate flexible scheduling and avoid resource waste. If several other storage media can only provide 1 GB of storage space each, the 1GB respectively corresponding to these storage media can be configured as a group to improve the efficiency of resource orchestration and resource scheduling in the edge cloud computing system.

In addition, in the step 202, the central management and control device can also acquire physical resource information of a physical resource in the edge cloud computing system and can determine resource metadata of the created cloud computing resource based on the acquired physical resource information.

In an illustrated implementation, the cloud computing resource may include heterogeneous resources composed of cloud computing resources of multiple resource types. The resource type may specifically include, but is not limited to, computing resources, storage resources, network resources, etc.

For example, the cloud computing resource may include one or more of the following: heterogeneous computing resources, heterogeneous storage resources, and heterogeneous network resources. The heterogeneous computing resources may specifically include, but are not limited to: x86 microprocessors, ARM boards, GPU (Graphics Processing Unit) resources, and other forms; the heterogeneous storage resources may specifically include, but are not limited to: block storage, file storage, object storage and other forms; the heterogeneous network resources may specifically include, but are not limited to: VPC (Virtual Private Cloud), LB (Load Balance), NAT (Network Address Translation) and other forms.

In an illustrated implementation, the at least one edge cloud node included in the edge cloud computing system may include IDCs distributed in different location areas; the at least one resource orchestration dimension may include one or more of the following: a location area where the edge cloud node hosting the cloud computing resource is located, a resource type of the cloud computing resource, and an operator to which the cloud computing resource belong.

For example, it is possible to configure the resource orchestration dimensions as country, province, area (such as East China, North China, etc.), city, etc., according to different coverage of location areas; it is possible to configure the resource orchestration dimension as data center (IDC), edge node service room (ENS room), etc., according to construction manners of distributed data centers; it is possible to configure the resource management dimensions as computing resources, storage resources, and network resources according to the resource types of cloud computing resources.

It should be noted that in terms of the specific dimension of the at least one resource orchestration dimension, it can be flexibly configured and expanded by those skilled in the art according to actual requirements. This specification does not impose particular limitations and cannot exhaustively list all possibilities.

Step 204, in response to a cloud computing instance creation requirement built by a tenant based on at least part of the at least one resource orchestration dimension, determine, from the cloud computing resource set corresponding to each resource orchestration dimension, a cloud computing resource set corresponding to the at least part of the at least one resource orchestration dimension, and determine, from the determined cloud computing resource set, a target cloud computing resource that matches the cloud computing instance creation requirement.

For example, the central management and control device 101 can classify, based on the three resource orchestration dimensions of city, computer room and operator, cloud computing resources hosted on the edge cloud node 102, the edge cloud node 103, and the edge cloud node 104, and create, based on a classification result, a cloud computer resource set corresponding to each resource orchestration dimension. Accordingly, a tenant corresponding to a terminal can build a cloud computing instance creation requirement based on at least part of the three resource orchestration dimensions. In response to the cloud computing instance creation requirement built by the tenant based on the resource orchestration dimension of city as [Hangzhou City, a resource quantity, . . . ] , the central management and control device 101 can determine a cloud computing resource set corresponding to the resource orchestration dimension of city from the pre-created cloud computing resource sets respectively corresponding to the three resource orchestration dimensions of city, computer room and operator, and can further determine a cloud computing resource that matches the cloud computing instance creation requirement [Hangzhou City, a resource quantity, . . . ] as a target cloud computing resource to be scheduled.

In a possible embodiment, the central management and control device can provide an externally accessible interface for demand submission (for example, an open API (Application Programming Interface)), which may be a web page, an application page, or a command window, etc.; the interface for demand submission allows a tenant to submit a cloud computing instance creation requirement to the central management and control device, that is, description information for a cloud computing instance to be created. The cloud computing instance creation requirement may include, but is not limited to an edge cloud node selection parameter and/or a resource selection parameter; the edge cloud node selection parameter may include a scheduling domain and/or a performance requirement for the edge cloud node, etc.; the resource selection parameter may include a resource type, a resource quantity, and a performance requirement for a resource device, etc. Further, the central management and control device can perform resource scheduling for the at least one edge cloud node according to the cloud computing instance creation requirement, to enable the scheduled edge cloud node to create a cloud computing instance for the tenant based on the scheduled cloud computing resource, or to enable the scheduled edge cloud node to reserve the scheduled cloud computing resource for the tenant.

In an illustrated implementation, the cloud computing instance may be divided into multiple instance types. During implementation, the cloud computing instance may specifically include one or more of the following: a container instance, a virtual machine instance, and an application instance.

For example, the container instance may specifically include a container instance created on a virtual machine and/or a bare metal container instance created on a physical machine; the virtual machine instance may specifically include a virtual machine instance created on a physical machine; the application instance may specifically include an application instance created on a physical machine or a virtual machine.

It should be noted that, in the step 204, the target cloud computing resource may be a resource set including one or more cloud computing resources that match the cloud computing instance creation requirement. The resource set corresponding to the target cloud computing resource may include cloud computing resources of different resource types, and may also include heterogeneous cloud computing resources.

Step 206, perform scheduling for the target cloud computing resource, to create a cloud computing instance that meets the cloud computing instance creation requirement on an edge cloud node hosting the target cloud computing resource, and return cloud computing instance information of the created cloud computing instance to the tenant.

For example, in response to the cloud computing instance creation requirement of [Hangzhou City, a resource quantity, . . . ] submitted by a tenant, the central management and control device 101 can perform scheduling, after determining a target cloud computing resource that matches the cloud computing instance creation requirement, for the determined target cloud computing resource, to create a cloud computing instance that meets the cloud computing instance creation requirement on an edge cloud node hosting the target cloud computing resource, and can return cloud computing instance information of the created cloud computing instance to the tenant, that is, can deliver the cloud computing instance produced by the edge cloud node hosting the target cloud computing resource, to the tenant.

In the step 206, a possible resource scheduling manner includes: the central management and control device 101 can determine the edge cloud node hosting the target cloud computing resource as a target edge cloud node, and control a corresponding resource device in the target edge cloud node to perform resource allocation or resource reservation, to utilize the target cloud computing resource scheduled in the target edge cloud node to provide a corresponding cloud computing service for the tenant.

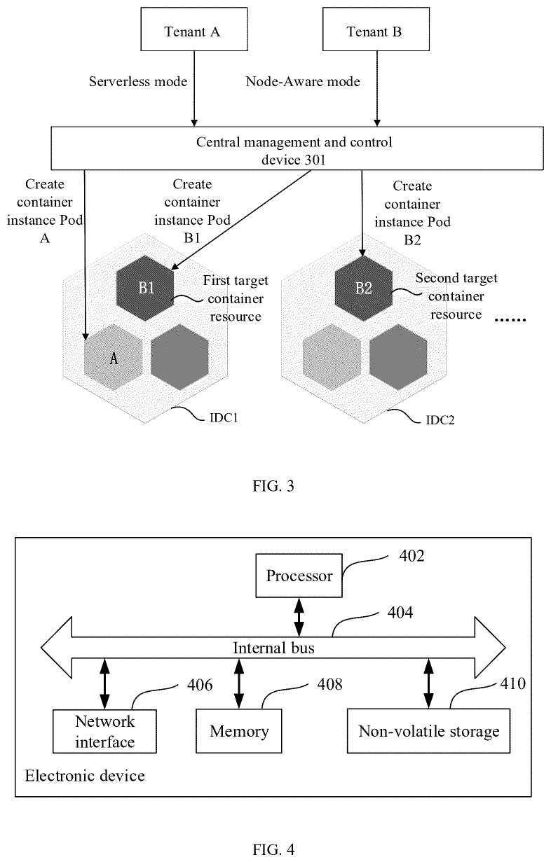

In order to enable those skilled in the art to better understand the technical solutions in the embodiment of this specification, an embodiment in this specification is described below by taking an example where the cloud computing instance is a container instance and the edge cloud nodes are IDCs distributed in different location areas, in combination with a schematic architecture diagram as shown in FIG. 3.

Please refer to FIG. 3, which is a schematic diagram of a system architecture of another distributed edge cloud computing system illustrated by an illustrative embodiment. One or more cloud computing instance creation methods provided in this specification may be applied to a central management and control device 301 as shown in FIG. 3. As shown in FIG. 3, the at least one edge cloud node interconnected with the central management and control device 301 may include IDC1, IDC2, . . . , etc.

Each edge cloud node of the at least one edge cloud node may host cloud computing resources of different resource types. The central management and control device 301 can perform resource orchestration, based on at least one resource orchestration dimension, for the cloud computing resources on the edge cloud nodes, to create the cloud computing resource set corresponding to each resource orchestration dimension of the at least one resource orchestration dimension.

The central management and control device 301 can also provide an externally accessible open API as an interface for submitting a cloud computing instance creation requirement, and a tenant can submit the cloud computing instance creation requirement to the central management and control device 301 through the open API.

In this specification, the cloud computing instance creation service provided by the central management and control device for the tenant may include a first service mode and a second service mode. The first service mode may include a service mode where the tenant is unaware of a logical resource object corresponding to a cloud computing resource used to create a cloud computing instance; and the second service mode may include a service mode where the tenant is capable of perceiving the logical resource object corresponding to the cloud computing resource used to create the cloud computing instance.

The first service mode may be a Serverless mode; under this service mode, the tenant may simply need to conveniently and efficiently utilize the edge cloud. Therefore, the tenant may simply need to obtain the cloud computing instance delivered to him that meets the cloud computing instance creation requirement, without concerning himself with the target cloud computing resource used to create the cloud computing instance.

The second service mode may be a Node-Aware mode, and may also be referred to as an LRO-Aware (Logical Resource Object Aware) mode; under this service mode, in addition to the need for conveniently and efficiently utilizing the edge cloud, the tenant also needs to learn the target cloud computing resource used to create the cloud computing instance. Therefore, in addition to delivering the cloud computing instance that meets the cloud computing instance creation requirement to the tenant, it is also necessary to return to the tenant logical resource object information of a logical resource object corresponding to the target cloud computing resource.

During implementation, in the step 206, the creation of the cloud computing instance that meets the cloud computing instance creation requirement and returning of the cloud computing instance information of the created cloud computing instance to the tenant may specifically include: determining a service mode corresponding to the cloud computing instance creation requirement; if it is determined that the service mode corresponding to the cloud computing instance creation requirement is the first service mode, creating the cloud computing instance that meets the cloud computing instance creation requirement, and returning the cloud computing instance information of the created cloud computing instance to the tenant; if it is determined that the service mode corresponding to the cloud computing instance creation requirement is the second service mode, creating the cloud computing instance that meets the cloud computing instance creation requirement, and returning the cloud computing instance information of the created cloud computing instance and the logical resource object information of the logical resource object corresponding to the target cloud computing resource to the tenant.

For example, as shown in FIG. 3, in response to a container instance creation requirement built by a tenant A based on the at least part of the at least one resource orchestration dimension (such as creating n container(s) of xx specification(s) at a certain location, where n may be any positive integer), the central management and control device 301 can determine the target cloud computing resource that matches the container instance creation requirement from the cloud computing resource set corresponding to each resource orchestration dimension. Further, the central management and control device 301 can determine that the service mode corresponding to the container instance creation requirement is the Serverless mode, and then can perform scheduling for the target cloud computing resource, to create a container instance Pod A that meets the container instance creation requirement on the edge cloud node IDC1 hosting the target cloud computing resource, and the central management and control device 301 can return container instance information of the created container instance Pod A to tenant A.

It should be noted that, in the above-illustrated embodiment, the specific information content of the container instance information is not limited in this specification. For example, the container instance information may specifically include, but is not limited to, an instance identifier of the container instance, a creation time of the container instance, the number of containers included in the container instance, a container specification of each container included in the container instance, etc.

For another example, as shown in FIG. 3, in response to a first container instance creation requirement and a second container instance creation requirement built by a tenant B based on the at least part of the at least one resource orchestration dimension, the central management and control device 301 can determine, from the cloud computing resource set corresponding to each resource orchestration dimension, a first target cloud computing resource that matches the first container instance creation requirement, and a second target cloud computing resource that matches the second container instance creation requirement. Further, the central management and control device 301 can determine that the service mode corresponding to the first container instance creation requirement and the second container instance creation requirement is the Node-Aware mode, then perform scheduling for the first target cloud computing resource and the second target cloud computing resource, to create a container instance Pod B1 that meets the first container instance creation requirement on the edge cloud node IDC1 hosting the first target cloud computing resource, and a container instance Pod B2 that meets the second container instance creation requirement on the edge cloud node IDC2 hosting the second target cloud computing resource, and return container instance information of the created container instance Pod B1 and container instance Pod B2 to the tenant B.

It should be noted that, in the above-illustrated embodiment, based on the fact that the container instance Pod B1 and the container instance Pod B2 created for the tenant B are located on the edge cloud node IDC1 and the edge cloud node IDC2, respectively, it can be seen that in the technical solution of this specification, the edge cloud node where the container instance created for the tenant is located is primarily related to the container instance creation requirement built by the tenant, and is not necessarily determined by whether the tenant is closer to one edge cloud node than another.

In a possible embodiment, the determining the service mode corresponding to the cloud computing instance creation requirement may specifically include: determining a service mode corresponding to the tenant as the service mode corresponding to the cloud computing instance creation requirement; or, the cloud computing instance creation requirement further includes a service mode configured for a cloud computing instance to be created.

In practical applications, the logical resource object can be created during a cloud computing resource orchestration phase or may be generated during a cloud computing instance creation phase.

In an illustrated implementation, the logical resource object corresponding to the target cloud computing resource can be created during the cloud computing resource orchestration phase. During implementation, the creating the cloud computing instance that meets the cloud computing instance creation requirement, and returning the cloud computing instance information of the created cloud computing instance and the logical resource object information of the logical resource object corresponding to the target cloud computing resource to the tenant specifically can include: creating the cloud computing instance that meets the cloud computing instance creation requirement, acquiring the logical resource object corresponding to the target cloud computing resource created in the resource orchestration phase, and returning the cloud computing instance information of the created cloud computing instance and the logical resource object information of the acquired logical resource object to the tenant.

For example, in the step 202, when resource orchestration is performed on the cloud computing resource hosted on the at least one edge cloud node to create the cloud computing resource set corresponding to each resource orchestration dimension, a corresponding logical resource object may be created for each cloud computing resource included in the created cloud computing resource set, and a logical resource object identifier for uniquely identifying the logical resource object globally can be assigned to each logical resource object. Subsequently, in response to the first container instance creation requirement built by the tenant B, the central management and control device 301 can determine the first target cloud computing resource that matches the first container instance creation requirement. Further, the central management and control device 301 determines that the service mode corresponding to the first container instance creation requirement is the Node-Aware mode, and it can perform scheduling for the first target cloud computing resource, to create the container instance Pod B1 that meets the first container instance creation requirement on the edge cloud node IDC1 hosting the first target cloud computing resource, and it can acquire a logical resource object IDC1.node1 corresponding to the first target cloud computing resource created in the resource orchestration phase, and return the container instance information of the created container instance Pod B1 and the logical resource object information of the logical resource object IDC1.node1 to the tenant B.

In another illustrated implementation, the logical resource object corresponding to the target cloud computing resource can be created during the cloud computing instance creation phase. During implementation, the creating the cloud computing instance that meets the cloud computing instance creation requirement, and returning the cloud computing instance information of the created cloud computing instance and the logical resource object information of the logical resource object corresponding to the target cloud computing resource to the tenant specifically may include: creating the cloud computing instance that meets the cloud computing instance creation requirement, creating the logical resource object corresponding to the target cloud computing resource, and returning the cloud computing instance information of the created cloud computing instance and the logical resource object information of the created logical resource object to the tenant.

For example, in response to the second container instance creation requirement built by the tenant B, the central management and control device 301 can determine the second target cloud computing resource that matches the second container instance creation requirement. Further, the central management and control device 301 determines that the service mode corresponding to the second container instance creation requirement is the Node-Aware mode, and it can perform scheduling for the second target cloud computing resource, to create the container instance Pod B2 that meets the second container instance creation requirement on the edge cloud node IDC2 hosting the second target cloud computing resource, and it can create a logical resource object IDC2.node1 corresponding to the second target cloud computing resource, and return the container instance information of the created container instance Pod B2 and the logical resource object information of the logical resource object IDC2.node1 to the tenant B.

It should be noted that, in the above-illustrated embodiment, the “node” in the Node-Aware mode does not refer to a certain edge cloud node or a physical device in the edge cloud computing system, instead, it refers to a logical resource object corresponding to the cloud computing resource. The logical resource object that can be perceived by the tenant may include a logical resource object corresponding to a cloud computing resource allocated or reserved by the central management and control device for the tenant.

In an illustrated implementation, under the second service mode, although the tenant has the capability to perceive the logical resource object corresponding to the target cloud computing resource, the tenant is not required to immediately enable this perceiving capability. Therefore, during the process of delivering the cloud computing instance to the tenant, it is possible to, by default, only return the cloud computing instance information of the created cloud computing instance to the tenant, and the logical resource object information of the logical resource object that is allowed to be perceived by the tenant is not directly returned initially. The logical resource object information of the logical resource object that is allowed to be perceived by the tenant may be provided to the tenant upon active queries from the tenant.

During implementation, the returning of the cloud computing instance information of the created cloud computing instance and the logical resource object information of the logical resource object corresponding to the target cloud computing resource to the tenant may specifically include: returning the cloud computing instance information of the created cloud computing instance to the tenant; in response to a query request submitted by the tenant for the logical resource object corresponding to the target cloud computing resource, returning the logical resource object information of the logical resource object corresponding to the target cloud computing resource to the tenant.

In one or more of the implementations illustrated above, object information of the logical resource object may specifically include at least part of data in resource metadata of a cloud computing resource corresponding to the logical resource object. It should be noted that in this case, since there is a correspondence between “logical resource object information-logical resource object-cloud computing resource-resource metadata of the cloud computing resource”, the tenant can at most perceive the logical resource object. As the resource metadata of the cloud computing resource and the logical resource object corresponding to the cloud computing resource are uniformly maintained by the central management and control device, data consistency can be guaranteed. In the related art, when tenants orchestrate their own resources by themselves, resource information maintained by the tenants may not be synchronized to management and control devices in the edge cloud computing system in a timely manner, resulting in data inconsistency.

In an illustrated implementation, under the second service mode, the tenants are enabled build their own resource management and control unit based on the logical resource object information of the logical resource object they have obtained and their service requirements, thereby improving the efficiency of the tenants' edge cloud utilization.

During implementation, before or simultaneously with the step 204, the method may further include: in response to a resource scheduling strategy configured by the tenant based on the logical resource object information of the logical resource object, determining, from the cloud computing resource set corresponding to each resource orchestration dimension, a cloud computing resource set that matches the resource scheduling strategy as a candidate cloud computing resource set. In such a case, the determining, from the cloud computing resource set corresponding to each resource orchestration dimension, the cloud computing resource set corresponding to the at least part of the at least one resource orchestration dimension specifically may include: determining the cloud computing resource set corresponding to the at least part of the at least one resource orchestration dimension from the determined candidate cloud computing resource set.

Following the embodiments illustrated above, more examples are given for illustration. After obtaining the logical resource object information of the logical resource object returned by the central management and control device, the tenant can configure the corresponding resource scheduling strategy according to the logical resource object information and the actual service requirement, and submit the resource scheduling strategy to the central management and control device; in response to the resource scheduling strategy configured by the tenant based on the logical resource object information of the logical resource object, the central management and control device can determine, from the created cloud computing resource set corresponding to each resource orchestration dimension, the cloud computing resource set that matches the resource scheduling strategy as the candidate cloud computing resource set; further, in response to the cloud computing instance creation requirement built by the tenant based on the at least part of the at least one resource orchestration dimension, the central management and control device can further determine the cloud computing resource set corresponding to the at least part of the at least one resource orchestration dimension from the determined candidate cloud computing resource set.

It should be noted that in the above-illustrated implementation, in the case that the tenant can perceive the logical resource object information of the logical resource object corresponding to the target cloud computing resource, the tenant can customize the resource scheduling strategy according to the actual service requirement. This is equivalent to the process by which the central management and control device determines the target cloud computing resource in response to the cloud computing instance creation requirement built by the tenant. The resource scheduling strategy is taken as an additional constrained condition, which can improve the efficiency of determining the target cloud computing resource, thereby improving the creation efficiency of creating the cloud computing instance for the tenant.

From the aforementioned technical solution, it can be seen that, on the one hand, the central management and control device (i.e., the platform side) in the distributed edge cloud computing system can perform resource orchestration, based on the at least one resource orchestration dimension, for the cloud computing resource hosted on the edge cloud node, to realize resource cloud migration in an efficient, flexible and scalable manner.

On the other hand, the central management and control device can perform resource orchestration for the cloud computing resource based on the at least one resource orchestration dimension, and the tenant can build the cloud computing instance creation requirement based on the at least one resource orchestration dimension. Therefore, through a unified multi-dimensional resource modeling strategy, the process of orchestrating the cloud computing resource is decoupled from the process of producing the cloud computing instance, while it is possible to seamlessly bridge the workflow between resource orchestration by the central management and control device and tenants' edge cloud utilization, making the model for resource management and control and instance production transparent, thereby improving the efficiency of tenants' edge cloud utilization.

On the further hand, in the edge cloud utilization process, tenants are not required to focus on underlying physical resources corresponding to individual edge cloud nodes, nor do they need to learn complex cloud usage strategies of various cloud providers. The tenants only need to build the cloud computing instance creation requirement based on the at least one resource orchestration dimension, and the central management and control device can determine the cloud computing resource that matches the cloud computing instance creation requirement as the target cloud computing resource from the cloud computing resource set, and can perform scheduling for the determined target cloud computing resource, to create the cloud computing instance that meets the cloud computing instance creation requirement on the corresponding edge cloud node. This approach allows the platform side to adopt a “cloud-neutral” posture, providing tenants with a more flexible, efficient, and scalable manner of utilizing the edge cloud, thereby creating more service value for the tenants, and tenants are not bound by the platform side, which can improve their experience in utilizing the edge cloud.

Corresponding to the above-described embodiments of the cloud computing instance creation method, this specification further provides an embodiment of a cloud computing instance creation apparatus.

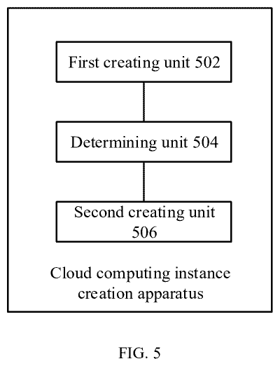

Please refer to FIG. 4, which is a hardware structural diagram of an electronic device where a cloud computing instance creation apparatus is located, illustrated by an illustrative embodiment. At the hardware level, the device includes a processor 402, an internal bus 404, a network interface 406, a memory 408, and a non-volatile storage 410, and, of course, it may further include hardware required for other services. One or more embodiments of this specification may be implemented in software, for example, by the processor 402 reading the corresponding computer program from the non-volatile storage 410 into the memory 408 and then executing it. Certainly, in addition to software implementations, one or more embodiments of this specification do not preclude other implementations, such as logic devices or a combination of software and hardware, etc. This is to say that the executing entity of the following processing flows are not limited to various logic units, but may also be hardware or logic devices.

Please refer to FIG. 5, which is a block diagram of a cloud computing instance creation apparatus illustrated by an illustrative embodiment. The cloud computing instance creation apparatus may be applied to the electronic device shown in FIG. 4 to implement the technical solution of this specification. The apparatus is applied to a central management and control device in a distributed edge cloud computing system, which further includes at least one edge cloud node interconnected with the central management and control device; and the apparatus may include:
a first creating unit 502, configured to: perform resource orchestration, based on at least one resource orchestration dimension, for a cloud computing resource hosted on the at least one edge cloud node, to create a cloud computing resource set corresponding to each resource orchestration dimension of the at least one resource orchestration dimension;
a determining unit 504, configured to: in response to a cloud computing instance creation requirement built by a tenant based on at least part of the at least one resource orchestration dimension, determine, from the cloud computing resource set corresponding to each resource orchestration dimension, a cloud computing resource set corresponding to the at least part of the at least one resource orchestration dimension, and determine, from the determined cloud computing resource set, a target cloud computing resource that matches the cloud computing instance creation requirement;
a second creating unit 506, configured to: perform scheduling for the target cloud computing resource, to create a cloud computing instance that meets the cloud computing instance creation requirement on an edge cloud node hosting the target cloud computing resource, and return cloud computing instance information of the created cloud computing instance to the tenant.

In this embodiment, a cloud computing instance creation service provided by the central management and control device for the tenant includes a first service mode and a second service mode; where the first service mode includes a service mode where the tenant is unaware of a logical resource object corresponding to a cloud computing resource used to create a cloud computing instance; and the second service mode includes a service mode where the tenant is capable of perceiving the logical resource object corresponding to the cloud computing resource used to create the cloud computing instance;
the second creating unit 506 is specifically configured to:
determine a service mode corresponding to the cloud computing instance creation requirement;
if it is determined that the service mode corresponding to the cloud computing instance creation requirement is the first service mode, create the cloud computing instance that meets the cloud computing instance creation requirement, and return the cloud computing instance information of the created cloud computing instance to the tenant;
if it is determined that the service mode corresponding to the cloud computing instance creation requirement is the second service mode, create the cloud computing instance that meets the cloud computing instance creation requirement, and return the cloud computing instance information of the created cloud computing instance and logical resource object information of a logical resource object corresponding to the target cloud computing resource to the tenant.

In this embodiment, the second creating unit 506 is specifically configured to:
create the cloud computing instance that meets the cloud computing instance creation requirement, create the logical resource object corresponding to the target cloud computing resource, and return the cloud computing instance information of the created cloud computing instance and the logical resource object information of the created logical resource object to the tenant; or,
create the cloud computing instance that meets the cloud computing instance creation requirement, acquire the logical resource object corresponding to the target cloud computing resource created in a resource orchestration phase, and return the cloud computing instance information of the created cloud computing instance and the logical resource object information of the acquired logical resource object to the tenant.

In this embodiment, the second creating unit 506 is specifically configured to:
return the cloud computing instance information of the created cloud computing instance to the tenant;
in response to a query request submitted by the tenant for the logical resource object corresponding to the target cloud computing resource, return the logical resource object information of the logical resource object corresponding to the target cloud computing resource to the tenant.

In this embodiment, object information of the logical resource object includes at least part of data in resource metadata of a cloud computing resource corresponding to the logical resource object.

In this embodiment, the determining unit 504 is further configured to:
in response to a resource scheduling strategy configured by the tenant based on the logical resource object information of the logical resource object, determine, from the cloud computing resource set corresponding to each resource orchestration dimension, a cloud computing resource set that matches the resource scheduling strategy as a candidate cloud computing resource set;
determine the cloud computing resource set corresponding to the at least part of the at least one resource orchestration dimension from the determined candidate cloud computing resource set.

In this embodiment, where the cloud computing instance includes one or a combination of more of following: a container instance, a virtual machine instance, or an application instance.

In this embodiment, the container instance includes: a container instance created on a virtual machine; and/or a bare metal container instance created on a physical machine.

In this embodiment, the cloud computing resource includes heterogeneous resources composed of cloud computing resources of multiple resource types; and
the cloud computing resource includes one or a combination of more of following: heterogeneous computing resources, heterogeneous storage resources, or heterogeneous network resources.

In this embodiment, the at least one edge cloud node includes an Internet data center IDC distributed in different location areas;
the at least one resource orchestration dimension includes one or a combination of more of following: a location area where an edge cloud node hosting a cloud computing resource is located, a resource type of cloud computing resource, or an operator to which a cloud computing resource belongs.

Through the aforementioned embodiments, on the one hand, the central management and control device (i.e., the platform side) in the distributed edge cloud computing system can perform resource orchestration, based on the at least one resource orchestration dimension, for the cloud computing resource hosted on the edge cloud node, to realize resource cloud migration in an efficient, flexible and scalable manner.

On the other hand, the central management and control device can perform resource orchestration for the cloud computing resource based on the at least one resource orchestration dimension, and the tenant can build the cloud computing instance creation requirement based on the at least one resource orchestration dimension. Therefore, through a unified multi-dimensional resource modeling strategy, the process of orchestrating the cloud computing resource is decoupled from the process of producing the cloud computing instance, while it is possible to seamlessly bridge the workflow between resource orchestration by the central management and control device and tenants' edge cloud utilization, making the model for resource management and control and instance production transparent, thereby improving the efficiency of tenants' edge cloud utilization.

On the further hand, in the edge cloud utilization process, tenants are not required to focus on underlying physical resources corresponding to individual edge cloud nodes, nor do they need to learn complex cloud usage strategies of various cloud providers. The tenants only need to build the cloud computing instance creation requirement based on the at least one resource orchestration dimension, and the central management and control device can determine the cloud computing resource that matches the cloud computing instance creation requirement as the target cloud computing resource from the cloud computing resource set, and can perform scheduling for the determined target cloud computing resource, to create the cloud computing instance that meets the cloud computing instance creation requirement on the corresponding edge cloud node. This approach allows the platform side to adopt a “cloud-neutral” posture, providing tenants with a more flexible, efficient, and scalable manner of utilizing the edge cloud, thereby creating more service value for the tenants, and tenants are not bound by the platform side, which can improve their experience in utilizing the edge cloud.

The implementation process of the functions and effects of each unit in the aforementioned apparatus is specifically described in the implementation process of the corresponding steps in the aforementioned method, which will not be repeated here.

Since the apparatus embodiments are substantially corresponding to the method embodiments, for relevant parts of the apparatus embodiments, reference may be made to the partial description of the method embodiments. The apparatus embodiments described above are merely illustrative. The units described as separate components may be or may not be physically separated, and the components shown as units may be or may not be physical units, that is, they may be located in one place or may be distributed over a plurality of network units. Some or all of the modules may be selected according to actual needs to achieve the purpose of the solution of this specification, which can be understood and implemented by a person skilled in the art without paying any creative work.

The systems, apparatuses, modules, or units illustrated in the aforementioned embodiments may be specifically implemented by computer chips or entities, or by products with certain functions. A typical implementation device is a computer, which may be in the form of a personal computer, laptop computer, cellular phone, camera phone, smartphone, personal digital assistant, media player, navigation device, email sending and receiving device, game console, tablet computer, wearable device, or a combination of any several of these devices.

In a typical configuration, a computer includes one or more processors (CPU (Central Processing Unit)), input/output interfaces, network interfaces, and memory.

Memory may include forms such as non-permanent storage (e.g., random access memory (RAM)) and/or non-volatile memory (e.g., read-only memory (ROM) or flash memory (flash RAM)) in computer-readable media. Memory is an example of a computer-readable medium.

Computer-readable media include both permanent and non-permanent, removable and non-removable media that can implement information storage using any method or technology. The information may be computer-readable instructions, data structures, program modules, or other data. Examples of computer storage media include, but are not limited to, phase change memory (PRAM), static random access memory (SRAM), dynamic random access memory (DRAM), other types of random access memory (RAM), read-only memory (ROM), electrically erasable programmable read-only memory (EEPROM), flash memory or other memory technology, compact disk read-only memory (CD-ROM), digital versatile disk (DVD) or other optical storage, magnetic cassettes, magnetic disk storage, quantum memory, graphene-based storage media or other magnetic storage devices, or any other non-transmission media that can be used to store information that can be accessed by a computing device. According to the definition provided in this document, computer-readable media does not include temporary computer-readable media (transitory media), such as modulated data signals and carrier waves.

It should also be noted that the terms “comprise,” “include,” or any other variants thereof, are intended to cover non-exclusive inclusions, such that a process, method, product, or device that includes a series of elements includes not only those elements, but also other elements not explicitly listed or inherent to such process, method, product, or device. In the absence of more limitations, the elements defined by the phrase “comprising a . . . ” do not exclude the presence of additional identical element(s) in the process, method, product, or device that includes the said element.

The above describes specific embodiments of this specification. Other embodiments fall within the scope of the appended claims. In some cases, the actions or steps recited in the claims can be performed in an order different from that in the embodiments and still achieve desirable results. In addition, the processes depicted in the accompanying drawings do not necessarily require the particular order shown, or sequential order to achieve desirable results. In certain implementations, multitasking and parallel processing are also possible or may be advantageous.

The terms used in one or more embodiments of this specification are for the purpose of describing specific embodiments only and are not intended to limit the one or more embodiments of this specification. As used in one or more embodiments of this specification and the appended claims, the singular forms “a,” “an,” “said,” and “the” are intended to include the plural forms as well, unless the context clearly indicates otherwise. It should also be understood that the term “and/or” used herein refers to and encompasses any or all possible combinations of one or more of the associated listed items.

It should be understood that although the terms first, second, third, etc. may be used to describe various information in one or more embodiments of this specification, the information should not be limited to these terms. These terms are merely intended to distinguish information of the same type from one another. For example, without departing from the scope of one or more embodiments of this specification, first information may also be referred to as second information, and similarly, second information may also be referred to as first information. Depending on the context, the word “if” as used herein may be interpreted as “upon . . . ” or “when . . . ” or “in response to determining . . . ”.

The above description is merely a preferred embodiment of one or more embodiments of this specification and is not intended to limit one or more embodiments of this specification. Any modifications, equivalent substitutions, improvements, etc. made within the spirit and principles of one or more embodiments of this specification shall be included in the protection scope of one or more embodiments of this specification.

1. A cloud computing instance creation method applied to a central management and control device in a distributed edge cloud computing system; the edge cloud computing system further comprising at least one edge cloud node interconnected with the central management and control device; and the method comprising:
performing resource orchestration, based on at least one resource orchestration dimension, for a cloud computing resource hosted on the at least one edge cloud node, to create a cloud computing resource set corresponding to each resource orchestration dimension of the at least one resource orchestration dimension;
in response to a cloud computing instance creation requirement built by a tenant based on at least part of the at least one resource orchestration dimension, determining, from the cloud computing resource set corresponding to each resource orchestration dimension, a cloud computing resource set corresponding to the at least part of the at least one resource orchestration dimension, and determining, from the determined cloud computing resource set, a target cloud computing resource that matches the cloud computing instance creation requirement;
performing scheduling for the target cloud computing resource, to create a cloud computing instance that meets the cloud computing instance creation requirement on an edge cloud node hosting the target cloud computing resource, and return cloud computing instance information of the created cloud computing instance to the tenant.

2. The method according to claim 1, wherein a cloud computing instance creation service provided by the central management and control device for the tenant comprises a first service mode and a second service mode; wherein the first service mode comprises a service mode where the tenant is unaware of a logical resource object corresponding to a cloud computing resource used to create a cloud computing instance; and the second service mode comprises a service mode where the tenant is capable of perceiving the logical resource object corresponding to the cloud computing resource used to create the cloud computing instance;
wherein the creation of the cloud computing instance that meets the cloud computing instance creation requirement and returning of the cloud computing instance information of the created cloud computing instance to the tenant comprises:
determining a service mode corresponding to the cloud computing instance creation requirement;
if it is determined that the service mode corresponding to the cloud computing instance creation requirement is the first service mode, creating the cloud computing instance that meets the cloud computing instance creation requirement, and returning the cloud computing instance information of the created cloud computing instance to the tenant;
if it is determined that the service mode corresponding to the cloud computing instance creation requirement is the second service mode, creating the cloud computing instance that meets the cloud computing instance creation requirement, and returning the cloud computing instance information of the created cloud computing instance and logical resource object information of a logical resource object corresponding to the target cloud computing resource to the tenant.

3. The method according to claim 2, wherein the creating the cloud computing instance that meets the cloud computing instance creation requirement, and returning the cloud computing instance information of the created cloud computing instance and the logical resource object information of the logical resource object corresponding to the target cloud computing resource to the tenant, comprises:
creating the cloud computing instance that meets the cloud computing instance creation requirement, creating the logical resource object corresponding to the target cloud computing resource, and returning the cloud computing instance information of the created cloud computing instance and the logical resource object information of the created logical resource object to the tenant; or, creating the cloud computing instance that meets the cloud computing instance creation requirement, acquiring the logical resource object corresponding to the target cloud computing resource created in a resource orchestration phase, and returning the cloud computing instance information of the created cloud computing instance and the logical resource object information of the acquired logical resource object to the tenant.

4. The method according to claim 2, wherein the returning the cloud computing instance information of the created cloud computing instance and the logical resource object information of the logical resource object corresponding to the target cloud computing resource to the tenant comprises:
returning the cloud computing instance information of the created cloud computing instance to the tenant;
in response to a query request submitted by the tenant for the logical resource object corresponding to the target cloud computing resource, returning the logical resource object information of the logical resource object corresponding to the target cloud computing resource to the tenant.

5. The method according to claim 2, wherein object information of the logical resource object comprises at least part of data in resource metadata of a cloud computing resource corresponding to the logical resource object.

6. The method according to claim 2, further comprising:
in response to a resource scheduling strategy configured by the tenant based on the logical resource object information of the logical resource object, determining, from the cloud computing resource set corresponding to each resource orchestration dimension, a cloud computing resource set that matches the resource scheduling strategy as a candidate cloud computing resource set;
wherein the determining, from the cloud computing resource set corresponding to each resource orchestration dimension, the cloud computing resource set corresponding to the at least part of the at least one resource orchestration dimension comprises:
determining the cloud computing resource set corresponding to the at least part of the at least one resource orchestration dimension from the determined candidate cloud computing resource set.

7. The method according to claim 1, wherein the cloud computing instance comprises one or a combination of more of following: a container instance, a virtual machine instance, or an application instance;
wherein the container instance comprises at least one of following: a container instance created on a virtual machine; or a bare metal container instance created on a physical machine;
wherein the cloud computing resource comprises heterogeneous resources composed of cloud computing resources of multiple resource types; and the cloud computing resource comprises one or a combination of more of following: heterogeneous computing resources, heterogeneous storage resources, or heterogeneous network resources.

8-9. (canceled)

10. The method according to claim 1, wherein the at least one edge cloud node comprises an Internet data center (IDC) distributed in different location areas;
the at least one resource orchestration dimension comprises one or a combination of more of following: a location area where an edge cloud node hosting a cloud computing resource is located, a resource type of cloud computing resource, or an operator to which a cloud computing resource belongs.

11. (canceled)

12. An electronic device comprising a communication interface, a processor, a memory, and a bus, wherein the communication interface, the processor and the memory are interconnected to each other via the bus;
the memory stores machine-readable instructions therein, and the processor executes, by invoking the machine-readable instructions, following operations:
performing resource orchestration, based on at least one resource orchestration dimension, for a cloud computing resource hosted on at least one edge cloud node, to create a cloud computing resource set corresponding to each resource orchestration dimension of the at least one resource orchestration dimension;
in response to a cloud computing instance creation requirement built by a tenant based on at least part of the at least one resource orchestration dimension, determining, from the cloud computing resource set corresponding to each resource orchestration dimension, a cloud computing resource set corresponding to the at least part of the at least one resource orchestration dimension, and determining, from the determined cloud computing resource set, a target cloud computing resource that matches the cloud computing instance creation requirement;
performing scheduling for the target cloud computing resource, to create a cloud computing instance that meets the cloud computing instance creation requirement on an edge cloud node hosting the target cloud computing resource, and return cloud computing instance information of the created cloud computing instance to the tenant.

13. A machine-readable storage medium storing machine-readable instructions, when the machine-readable instructions are invoked and executed by a processor, to enable the processor to perform following operations:
performing resource orchestration, based on at least one resource orchestration dimension, for a cloud computing resource hosted on at least one edge cloud node, to create a cloud computing resource set corresponding to each resource orchestration dimension of the at least one resource orchestration dimension;
in response to a cloud computing instance creation requirement built by a tenant based on at least part of the at least one resource orchestration dimension, determining, from the cloud computing resource set corresponding to each resource orchestration dimension, a cloud computing resource set corresponding to the at least part of the at least one resource orchestration dimension, and determining, from the determined cloud computing resource set, a target cloud computing resource that matches the cloud computing instance creation requirement;
performing scheduling for the target cloud computing resource, to create a cloud computing instance that meets the cloud computing instance creation requirement on an edge cloud node hosting the target cloud computing resource, and return cloud computing instance information of the created cloud computing instance to the tenant.

14. The electronic device according to claim 12, wherein a cloud computing instance creation service provided by the electronic device for the tenant comprises a first service mode and a second service mode; wherein the first service mode comprises a service mode where the tenant is unaware of a logical resource object corresponding to a cloud computing resource used to create a cloud computing instance; and the second service mode comprises a service mode where the tenant is capable of perceiving the logical resource object corresponding to the cloud computing resource used to create the cloud computing instance;
wherein the machine-readable instructions are executed by the processor to further enable the processor to perform following operations:
determining a service mode corresponding to the cloud computing instance creation requirement;
if it is determined that the service mode corresponding to the cloud computing instance creation requirement is the first service mode, creating the cloud computing instance that meets the cloud computing instance creation requirement, and returning the cloud computing instance information of the created cloud computing instance to the tenant;
if it is determined that the service mode corresponding to the cloud computing instance creation requirement is the second service mode, creating the cloud computing instance that meets the cloud computing instance creation requirement, and returning the cloud computing instance information of the created cloud computing instance and logical resource object information of a logical resource object corresponding to the target cloud computing resource to the tenant.

15. The electronic device according to claim 14, wherein the machine-readable instructions are executed by the processor to further enable the processor to perform following operations:
creating the cloud computing instance that meets the cloud computing instance creation requirement, creating the logical resource object corresponding to the target cloud computing resource, and returning the cloud computing instance information of the created cloud computing instance and the logical resource object information of the created logical resource object to the tenant; or,
creating the cloud computing instance that meets the cloud computing instance creation requirement, acquiring the logical resource object corresponding to the target cloud computing resource created in a resource orchestration phase, and returning the cloud computing instance information of the created cloud computing instance and the logical resource object information of the acquired logical resource object to the tenant.

16. The electronic device according to claim 14, wherein the machine-readable instructions are executed by the processor to further enable the processor to perform following operations:
returning the cloud computing instance information of the created cloud computing instance to the tenant;
in response to a query request submitted by the tenant for the logical resource object corresponding to the target cloud computing resource, returning the logical resource object information of the logical resource object corresponding to the target cloud computing resource to the tenant.

17. The electronic device according to claim 14, wherein object information of the logical resource object comprises at least part of data in resource metadata of a cloud computing resource corresponding to the logical resource object.

18. The electronic device according to claim 14, wherein the machine-readable instructions are executed by the processor to further enable the processor to perform following operations:
in response to a resource scheduling strategy configured by the tenant based on the logical resource object information of the logical resource object, determining, from the cloud computing resource set corresponding to each resource orchestration dimension, a cloud computing resource set that matches the resource scheduling strategy as a candidate cloud computing resource set;
determining the cloud computing resource set corresponding to the at least part of the at least one resource orchestration dimension from the determined candidate cloud computing resource set.

19. The machine-readable storage medium according to claim 13, wherein a cloud computing instance creation service provided by a central management and control device for the tenant comprises a first service mode and a second service mode; wherein the first service mode comprises a service mode where the tenant is unaware of a logical resource object corresponding to a cloud computing resource used to create a cloud computing instance; and the second service mode comprises a service mode where the tenant is capable of perceiving the logical resource object corresponding to the cloud computing resource used to create the cloud computing instance;
wherein the the machine-readable instructions are invoked and executed by a processor to further enable the processor to perform following operations:
determining a service mode corresponding to the cloud computing instance creation requirement;
if it is determined that the service mode corresponding to the cloud computing instance creation requirement is the first service mode, creating the cloud computing instance that meets the cloud computing instance creation requirement, and returning the cloud computing instance information of the created cloud computing instance to the tenant;
if it is determined that the service mode corresponding to the cloud computing instance creation requirement is the second service mode, creating the cloud computing instance that meets the cloud computing instance creation requirement, and returning the cloud computing instance information of the created cloud computing instance and logical resource object information of a logical resource object corresponding to the target cloud computing resource to the tenant.

20. The machine-readable storage medium according to claim 19, wherein the machine-readable instructions are invoked and executed by a processor to further enable the processor to perform following operations:
creating the cloud computing instance that meets the cloud computing instance creation requirement, creating the logical resource object corresponding to the target cloud computing resource, and returning the cloud computing instance information of the created cloud computing instance and the logical resource object information of the created logical resource object to the tenant; or,
creating the cloud computing instance that meets the cloud computing instance creation requirement, acquiring the logical resource object corresponding to the target cloud computing resource created in a resource orchestration phase, and returning the cloud computing instance information of the created cloud computing instance and the logical resource object information of the acquired logical resource object to the tenant.

21. The machine-readable storage medium according to claim 19, wherein the machine-readable instructions are invoked and executed by a processor to further enable the processor to perform following operations:
returning the cloud computing instance information of the created cloud computing instance to the tenant;
in response to a query request submitted by the tenant for the logical resource object corresponding to the target cloud computing resource, returning the logical resource object information of the logical resource object corresponding to the target cloud computing resource to the tenant.

22. The machine-readable storage medium according to claim 19, wherein object information of the logical resource object comprises at least part of data in resource metadata of a cloud computing resource corresponding to the logical resource object.

23. The machine-readable storage medium according to claim 19, wherein the machine-readable instructions are invoked and executed by a processor to further enable the processor to perform following operations:
in response to a resource scheduling strategy configured by the tenant based on the logical resource object information of the logical resource object, determining, from the cloud computing resource set corresponding to each resource orchestration dimension, a cloud computing resource set that matches the resource scheduling strategy as a candidate cloud computing resource set; determining the cloud computing resource set corresponding to the at least part of the at least one resource orchestration dimension from the determined candidate cloud computing resource set.
